(19) United States
(12) Patent Application Publication
(10) Pub. No.: US 2026/0309575 A1
(43) Pub. Date: Oct. 8, 2026

(54) METHOD AND APPARATUS FOR TESTING THE TIGHTNESS OF A CONTAINER CLOSED BY A MEMBRANE

(71) Applicant: G.D S.P.A., BOLOGNA (IT)

(72) Inventors: Maria Eleonora CESARINI, BOLOGNA (IT); Stefano PARESCHI, BOLOGNA (IT); Alessio FRONTINI, BOLOGNA (IT)

(73) Assignee: G.D S.P.A., BOLOGNA (IT)

(21) Appl. No.: 18/998,622

(22) PCT Filed: Jul. 20, 2023
(86) PCT No.: PCT/IB2023/057411

§ 371 Date: Jan. 27, 2025

(30) Foreign Application Priority Data
Jul. 27, 2022 (IT) 102022000015789

(51) Int. Cl. G01M 3/38

(52) U.S. Cl. CPC G01M 3/38

(57) ABSTRACT

Method and apparatus for testing the tightness of a container (1) closed by a membrane (2), the method comprising the steps of detecting a first profile (N1) of the membrane (2) when container and membrane are in an initial force condition, modifying the initial force condition submitting the container (1) and/or the membrane (2) to a deforming action such as to induce a deformation of the membrane (2), interrupting the deforming action so as to restore the initial force condition, detecting a second profile (N2) of the membrane (2) after the deforming action has been interrupted, comparing the first profile (N1) with the second profile (N2) and identifying whether the first profile (N1) differs from the second profile (N2) by an amount equal to or greater than a predefined threshold, in order to verify whether the tightness of the container (1) is defective.

### DESCRIPTION

The present invention relates to a method and apparatus for testing the tightness of a container closed by a membrane.

The present invention is preferably, though not exclusively, applied to the field of manufacturing loose containers such as yoghurt pots, dessert pots, cups for pre-cooked foodstuffs, and capsules for brewing products, such as coffee, a field to which reference will be made hereinafter without losing generality.

In this context, the term “capsule” therefore refers to the product formed by the container provided with the closing membrane.

Typically, containers pertaining to this technical field are products having the shape of a glass element, essentially inverted truncated cone, or an equivalent shape, with the widest portion upwards where the container opening is provided, and typically made of polymeric materials.

In the capsule-manufacturing process, after the step of filling the container, wherein the brewing product is introduced into the container through the opening, the container is sealed by applying a membrane, acting as a closing lid, having a laminar structure, which is fixed to an edge of the container delimiting said opening.

The sealing operation, typically performed by welding or gluing or by an operation involving both of them, obtains an air-tight closure of the container such that the contents of the capsule, and the inert protective atmosphere possibly introduced therein, remain permanently separated from the external atmosphere, at least until the closing membrane is removed or perforated, i.e. upon perforation of the container, if required, when the capsule is used.

In the present disclosure as well as in the herein enclosed claims, certain terms and expressions are deemed to have, unless otherwise expressly indicated, the meaning expressed in the following definitions.

The term “membrane” refers to a body with a thin foil structure, intended to close an opening and susceptible to be deformed as a result of changes in pressure inside or outside the opening and acting thereon.

“Profile of the membrane” refers to the pattern of the membrane relative to a reference plane of the container, such as the plane defined by an edge of the container, in particular the edge of the opening port of the container, to which the membrane is attached.

“Membrane deformation” refers to a change in the shape of the membrane, wherein at least part of the membrane can be spaced from the reference plane of the container.

A container is “tightly closed” when it is hermetically closed, i.e. without the possibility of any appreciable gas/air exchange between the inside and outside of the container.

The container and membrane are submitted to an “initial force condition” when they are submitted to forces, e.g. including mechanical forces, pressure differences between the inside of the capsule and the external environment, electromagnetic forces, which define a state of the container closed by the membrane before it is submitted to the tightness test.

In the capsule packaging processes, a step of verifying the tightness of the container closed by the membrane, performed after the filling and sealing steps, is normally provided. In fact, it is crucial to ensure the integrity of the capsule air-tight closure in order to prevent contamination or oxidation of the product contained therein or possible leakage of the contents from the capsule. Defects that can compromise the air-tight closure may, for example, originate from cracks or tears in the container and/or in the closing membrane and/or interruptions in the area where the membrane is welded or bonded to the container.

A known testing system involves submitting the container to a compressive deforming action, such as by a localised squeezing action, in a section of its movement path, along which an inspection station is located. A load sensor is provided in the inspection station and is positioned to contact the membrane as the container is in transit, in order to detect possible changes in the pressure within the container and acting on the membrane. These internal pressure changes, induced by the squeezing action, tend to deform the membrane, e.g. by inducing a swelling of the membrane itself. As the pressure inside the container varies in case of tightness losses, due to the air escaping from the container, it is possible to recognize would-be tightness losses based on pressure changes detected by the inspection system, in order to later reject the container.

The Applicant observed that the deforming action of the container, both in terms of magnitude and duration of application, is crucial for implementing a control system that is effective in detecting losses of the container tightness. On the one hand, in fact, the force with which the deformation is applied, which must not be destructive of the container, is proportionally related to the increase in internal pressure, if referred to a tightly closed container, and this internal pressure is responsible for the deformation of the membrane. On the other hand, the time of application of the deforming force on the container, which must necessarily be compatible with the cycle time of the production line, is also a critical factor because it affects the amount of air that escapes from the container, in case of defects. In fact, the longer the deforming force is applied, the greater the amount of air escaping from the opening characterising the defect, and consequently the smaller the size of the openings that can be detected. This factor therefore becomes decisive for identifying tightness losses due to extremely small openings.

However, the Applicant found that, using the above-described testing mode, the classification of defects of containers is often not carried out accurately. The Applicant has in fact observed that the deforming action applied to the container, in the common operating conditions of the production line, does not often generate a sufficient overpressure to allow, within the time range available for the application of deformation, an escape of air from the container suitable for detecting defects generated by rather small openings.

It should be noted, merely by way of example, that in the reference sector it can be required that the smallest equivalent hole diameter, beyond which the tightness is classified as defective, be of the order of magnitude of a few hundred microns, such as 250 microns. For comparison purposes, consider that a human hair can have a maximum diameter of about 100 microns.

The Applicant also noted that the method of operating a load sensor in contact with the membrane can lead to inaccuracies in detecting defects, because in this case the measurement can be influenced by the position of the container. This inaccuracy can take place to a greater extent with containers bearing membranes with a concave profile, such a shape requiring a more incisive squeezing action of the container in the deforming action, which can, however, result in the container being lifted with the consequent risk of distorting the load sensor measurement.

The Applicant has perceived that in order to accurately detect tightness losses in containers provided with membranes of any profile, in particular with a concave pattern, it is desirable that the deforming action of the container be made independent of the action of detecting defects, preventing them from affecting each other, with the risk of compromising the accuracy of the result.

The Applicant also realised that the defect assessment could be more accurate when the measurement of the membrane deformation was compared not with an average standard value valid for all the capsules, but with a value measured on the capsule itself.

The Applicant finally found that detecting a first profile of the membrane with no deforming action on the container and/or membrane, subsequently applying such a deforming action, and detecting a second profile of the membrane once such deforming action had ceased, comparing the first and second profiles, could ensure accuracy in detecting tightness losses, generated even by extremely small openings, in containers with membranes bearing profiles of any surface pattern, and in particular concave ones.

Therefore, the present invention, in a first aspect thereof, is directed to a method for testing the tightness of a container closed by a membrane.

Preferably, the method comprises the step of detecting a first profile of the membrane, particularly when the container and the membrane are in an initial force condition.

Preferably, the method comprises the step of modifying the initial force condition by submitting at least one of said container and said membrane to at least one deforming action such as to induce a deformation of said membrane.

Preferably the method comprises the step of interrupting said at least one deforming action, in particular so as to substantially restore said initial force condition.

Preferably, the method comprises the step of detecting a second profile of said membrane after said at least one deforming action has been interrupted.

Preferably, the method comprises the step of comparing said first profile of the membrane with said second profile of the membrane.

Preferably, the method comprises the step of identifying whether said first profile differs from said second profile by an amount equal to or greater than a predefined threshold, in order to verify whether the tightness of said container is to be classified as defective.

The present invention, in a second aspect thereof, is directed to an apparatus for testing the tightness of a container closed by a membrane.

Preferably, the apparatus comprises a first detection unit configured to detect a first profile of the membrane.

Preferably said first detection unit is configured to detect the first profile of the membrane, particularly when said container and said membrane are in an initial force condition.

Preferably, the apparatus comprises a deforming unit arranged to exert a deforming action on at least one of said container and said membrane such as to induce a deformation of said membrane.

Preferably, the apparatus comprises a second detection unit configured to detect a second profile of the membrane.

Preferably said second detection unit is configured to detect the second profile of the membrane when the deforming action has ceased, in particular when said initial force condition is substantially restored.

Preferably the apparatus comprises a control unit, operatively connected to said first and second detection units.

Preferably the control unit is set up to compare said first profile with said second profile.

Preferably, the control unit is set up to identify whether said first profile differs from said second profile by an amount equal to or greater than a predefined threshold, in order to verify whether the tightness of said container is to be classified as defective.

Thanks to these features, the container and/or membrane deforming action is carried out substantially separately and independently of the action of detecting the profile of the membrane, and in any case in such a way as to prevent said actions from affecting each other, to the benefit of the reliability and accuracy of the result. In addition, returning the container back to the initial force condition after the deforming action has ceased, makes it advantageously possible not to affect the analysis of the profile of the membrane by forces which the container can be submitted to prior to the deforming action.

In at least one of the aforesaid aspects, the present invention may also have at least one of the preferred features set out hereinafter.

Preferably, the initial force condition is a rest condition, wherein said container and said membrane are not submitted to mechanical deforming actions.

Preferably, the initial force condition may represent a rest condition of the container, wherein the container is submitted only to the action of the force of gravity.

Preferably said container and said membrane in said initial force condition are in an atmospheric pressure environment.

Preferably the pressure in said container closed by said membrane is lower than said atmospheric pressure.

Preferably, the first profile and the second profile are detected by a same procedure.

The comparison between the first and second profile of the membrane is thereby made homogeneous, in order to make the identification of the tightness losses of the container reliable and accurate.

Preferably, the first profile is detected by optical scanning of said membrane.

Thanks to the optical scanning, which does not involve contact with the membrane, the detection of the profile of the membrane is not susceptible to factors that may affect the result, such as the use of sensors or probes that operate by contact with the membrane. The risk of possible mechanical jamming that can occur in the contact between the container and the sensor is further prevented.

The absence of contact in optical scanning detection also makes detection independent of container dimensions (which may vary depending on the supplier), in particular its height, as well as its positioning between the pressor elements of the deforming unit. This characteristic also makes it possible to reduce or avoid calibration or adjustment activities related to the above-mentioned aspects, thus saving time and costs.

Preferably, the optical scanning is extended over the entire surface of said membrane.

Preferably, the deforming action comprises at least one localised squeezing action of said container.

Preferably, the deforming action comprises a series of successive squeezing actions of said container.

A series of overpressure pulses is thereby generated, in succession to each other, which makes it more effective for air to escape from the container, particularly through small openings.

Preferably said series of squeezing actions comprises between 2 and 6, preferably 4, squeezing actions.

In an embodiment, said container is moved with a predetermined transport speed.

Preferably said transport speed is 750 capsules per minute, referring to a single row comprising a plurality of capsules aligned at a regular pitch along a conveying direction. Equally preferred, said transport speed is 1500 capsules per minute, with reference to two side-by-side rows, each row comprising a plurality of capsules aligned at a regular pitch along the transport direction.

In one embodiment said at least one squeezing action has a duration calculated as a function of said transport speed.

Preferably said at least one squeezing action has a duration of between 10 and 100 milliseconds, preferably between 25 and 30 milliseconds.

Preferably a release period of between 10 and 100 milliseconds, preferably between 20 and 25 milliseconds is provided between two successive squeezing actions.

Thereby, the duration of the squeezing action takes into account the transport speed of the container and can be calculated in such a way as to make the air escape from the container being moved more effective.

Preferably, the method also comprises detecting at least one temperature between the temperature of said container, the temperature of said membrane and the temperature inside said container closed by said membrane.

Preferably, said deforming action is activated at a time instant calculated according to said at least one detected temperature.

The temperature inside the capsule is also a function of the temperatures reached by the container and membrane during the step of welding or bonding them in order to form said capsule, and determines the volume of gases-including air-contained within the capsule. In particular, changes in temperature can negatively affect the reliability of the tightness test: an increase in temperature corresponds to an expansion of the volume of gases inside the capsule and thus to an increasingly less concave or more convex membrane, while a reduction in temperature corresponds to a contraction of the volume of these gases and an increasingly more concave or less convex membrane. Thanks to the temperature detection, it is therefore possible to activate the deformation function at a point in time when the temperature has settled within a certain tolerance range, in particular when temperature changes within the capsule due to welding or bonding are essentially zero. This prevents the container from being deformed when, for example, the gases therein are expanding due to the high welding temperature and the capsule would be at risk of breaking by bursting.

Preferably said at least one squeezing action comprises a rapid compression step and is followed by a gradual release step, wherein said rapid compression step has a shorter duration than a duration of said gradual release step.

A rapid compression step thereby allows to create a more effective overpressure pulse to push air faster out of the container, while a gradual release step of the squeezing action prevents air from being sucked back into the container.

Preferably said at least one squeezing action is carried out on diametrically opposite sides of said container.

The deforming action is thereby induced on the container with a substantial symmetry, counteracting any possible offset positioning that the container may assume.

Preferably, from said first profile and said second profile, a first volume and a second volume of space comprised between said membrane and a reference plane, respectively, are obtained.

Preferably, said comparison is made by comparing the values of said first volume and second volume.

Preferably said predefined threshold represents a percentage of the difference between said first volume and second volume, preferably normalised in relation to said first volume.

Preferably, said threshold normalised in relation to said first volume is between −15% and 30%.

In a preferred embodiment, the deforming unit comprises at least one pair of pressor elements, between which the container is led, to be submitted to a deforming action while transiting between said pressor elements.

Preferably, the pressor elements of said pair of pressor elements are rotatably supported about their respective rotation axes.

Preferably the rotation axes of the pressor elements are parallel to each other.

In this way, during the step of squeezing the container, a rotational movement is induced on the pressor element by the contact with the container, which prevents a relative slithering between the contact surfaces of the container and the pressor element from occurring, thus preserving the container from possible subsequent damages.

Preferably the centre to centre distance between the pressor elements of said at least one pair of pressor elements is adjustable.

The deforming unit can thereby be configured both to operate with containers of different sizes and to adjust the desirable deforming force acting on the container.

In a preferred embodiment, the apparatus comprises a plurality of pairs of said pressor elements, arranged one after the other, at a chosen relative distance, along an alignment direction.

A series of successive squeezing actions, which the container is submitted to, can be implemented.

Preferably, said alignment direction of said pairs of pressor elements corresponds to a direction of movement of the container.

Preferably at least one of said first and second detection units comprises a respective optical detection device.

In a preferred embodiment, the apparatus further comprises a temperature sensor to detect at least a temperature between container temperature, membrane temperature and temperature inside said container closed by said membrane.

In a preferred embodiment, the apparatus further comprises a container transport device, and said deforming unit is mounted on a stationary support structure of the transport device.

This makes it possible to carry out the tightness test step during the transport of the container, so that the time required for the tightness test step can be substantially embedded, at least in part, into the time lapse required to complete the capsule production cycle.

Preferably, the rotation axes of said pressor elements are directed perpendicular to the movement direction of the container.

It should be noted that some steps of the method described above can be independent of the order of execution reported. Furthermore, some steps can be optional. Furthermore, some steps of the method can be performed repetitively, or can be performed in series or in parallel with other steps of the method.

The features and advantages of the present invention will become clearer from the detailed description of an embodiment thereof shown, by way of non-limiting example, with reference to the appended drawings wherein:

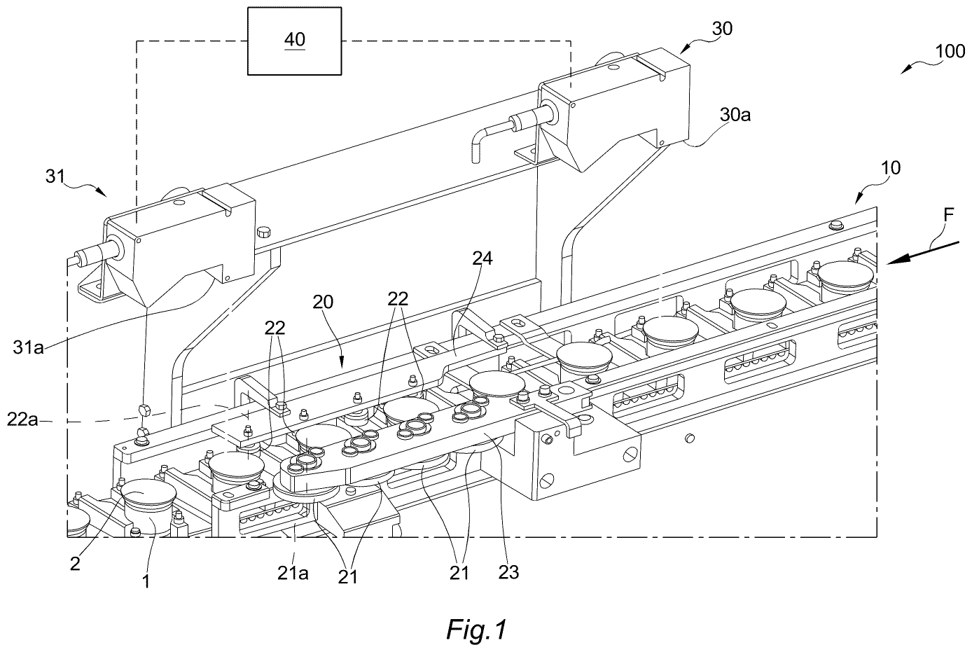

FIG. 1 is a schematic partial perspective view of an apparatus for testing the tightness of containers closed by a membrane, made according to the present invention and with certain details omitted for the sake of simplicity,

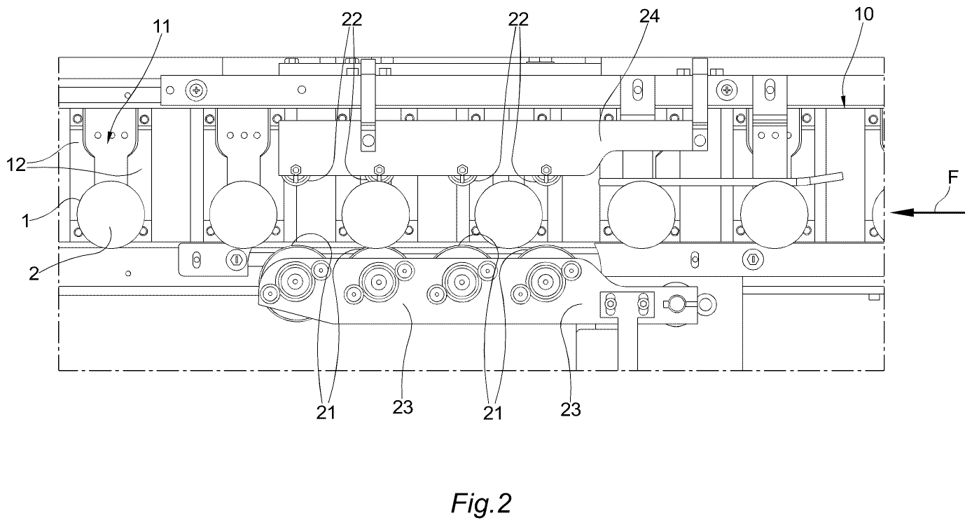

FIG. 2 is a plan partial view of the apparatus of FIG. 1,

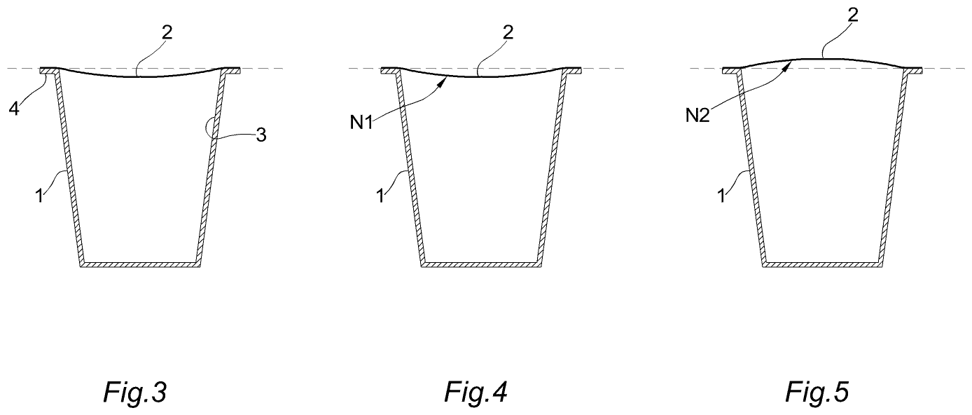

FIG. 3 is a schematic view in axial cross-section and to an enlarged scale of a container closed by a membrane that is suitable to be submitted to the tightness test using the apparatus of the previous Figures,

FIGS. 4 and 5 are views corresponding to the one in FIG. 3, wherein the container is shown in respective and distinct operating steps of the tightness test method used by the apparatus in FIGS. 1 and 2.

With reference to the above-mentioned Figures, 100 denotes an apparatus for testing the tightness of containers 1 closed by a membrane 2, made according to the present invention.

The containers 1, in this preferred embodiment, are configured to manufacture capsules for brewing products, such as coffee powder, and are for this purpose made in the shape of a truncated cone glass having a cavity with a wider portion directed upwards where an opening 3, communicating with the cavity of the container 1, is provided. The bulk product is introduced through the opening 3.

The container 1 is provided with an edge 4 delimiting the opening 3, made in the form of an annular crown, onto which the closing membrane 2 is fixed, for example by gluing or welding or by an operation involving both of them.

The membrane 2 is fixed to obtain an air-tight closure of the container in order to allow the contents of the capsule, and any inert protective atmosphere placed therein, to remain permanently separated from the external atmosphere, preferably until the capsule is used.

The apparatus 100 comprises a transport device 10, in the form of a belt or conveyor belt and configured to move a plurality of containers 1 along a transport direction F, from an inlet area (not shown) wherein they are located on the transport device by a feeding device (not shown) to an outlet area, also not shown, wherein the containers 1, having completed the tightness test step, are picked up and led to the next processing steps of the capsule production cycle.

In FIGS. 1 and 2, the containers 1 are arranged on the transport device 10, aligned to each other in a single row, as well as spaced with a regular pitch, along the transport direction F, that is rectilinear in this example.

Alternatively, it can be provided that the containers 1 are moved by the transport device 10 in two side-by-side rows, each row comprising a plurality of containers 1 aligned at a regular pitch along the transport direction F.

The containers 1 are transported with the respective bottom, located as vertically opposite to the membrane 2, resting on the transport device 10.

Seats 11 are also provided on the transport device 10 for holding the respective container 1 in position, made for instance with a pair of opposite abutment elements 12 between which the container can be positioned. The abutment elements 12 are shaped with curved profiles adapted to embrace, in a surface coupling, at least part of the container, to make sure it is stably retained in the corresponding seat.

The apparatus 100 also comprises a deforming unit 20, configured to exert a deforming action on the respective container 1 of the plurality of containers, suitable for testing the tightness.

Said deforming unit 20 is mounted on a stationary support structure of the transport device 10 and comprises a plurality of pairs of pressor elements, between which the respective container 1 transits during its movement on the transport device 10.

Each pair of pressor elements comprises a first pressor element 21 and a second pressor element 22, both of which are in the form of idle rollers rotatably supported about their respective rotation axes 21a, 22a, which are parallel to each other.

The pressor elements 21, 22 of each pair are configured to simultaneously interfere with the container 1 from diametrically opposite sides of the container, thus exerting a deforming action on the container.

In the example described, four pairs of pressor elements 21, 22, are provided that are arranged one after the other, in a relative alignment along the transport direction F, with a selected relative distance.

With such a configuration, each container 1 is submitted to four successive squeezing actions at the deforming unit 20.

In greater detail, the four pressor elements 21 are made with respective rollers rotatably supported on a plate 23, which is fixed in an adjustable manner on the stationary support structure of the transport device 10.

In a similar manner, the four pressor elements 22 are made with respective rollers rotatably supported on a plate 24, which is also fixed in an adjustable manner on the stationary support structure of the transport device 10.

The pressor elements 21 and 22 of each pair of pressor elements can be made with respective rollers of equal diameters, or of different diameters if there are special space requirements.

Preferably, such rollers are entirely made of or externally coated with a material with a hardness between 85 and 95 Shore A, such as 90 Shore A.

In the configuration of the example described, it is provided that the pressor element 22, which is intended to operate inside the container transport space, is made with a diameter smaller than the roller diameter with which the pressor element 21 is made.

If two side-by-side rows of containers 1 are to be moved, the deforming unit 20 can be configured constructively and functionally as follows.

Each pair of containers 1 comprises a first container and a second container moving side-by-side along the transport direction F, wherein the first container is submitted to the deforming action exerted by a first series of pairs of pressor elements 21, 22 and the second container is submitted to the deforming action exerted by a second series of pairs of pressor elements 21, 22.

The first and second series of pairs of pressor elements can be made as described above and shown in FIGS. 1 and 2, and are mounted in such a way as to be symmetrical in a mirror-like manner with respect to a vertical median plane of longitudinal symmetry of the transport device directed parallel to the transport direction F.

Alternatively, the first and second series of pairs of pressor elements can be arranged in a staggered manner, alternating a pair of pressor elements from the first series with a pair of pressor elements from the second series.

In a variant embodiment, a first series of pairs of pressor elements 21, 22 acting on the first container 1, and bearing in each pair a roller pressor element 22 located alongside the transport device and a roller pressor element 21 arranged within the transport space of the transport device can be provided.

On the second container 1, a second series of pairs of pressor elements is provided to act, wherein each pair comprises a distinct roller pressor element 22 located at the opposite side of the transport device, while the roller pressor element 22 of the first series of pairs of pressor elements is used as the pressor element within the transport space. In other words, the pressor element 22 in common with the two pairs of pressor elements is configured to simultaneously interfere with both the first and the second container.

In this configuration, it is provided that the pressor element 22 in common is susceptible to a relative slithering movement with the containers when it comes into contact with the first and second container.

In one embodiment, the pressor element 22 in common can be made in the form of a fixed abutment element susceptible of a relative slithering with the first and second containers when it contacts them during the deforming action.

Upstream of the deforming unit 20, with respect to the transport direction F, the apparatus 100 comprises a first detection unit 30 configured to detect a first profile of the membrane 2 of the container, before the latter is submitted to the deforming action.

Downstream of the deforming unit 20, with respect to the transport direction F, the apparatus 100 comprises a second detection unit 31 configured to detect a second profile of the container membrane 2 when the deforming action to which the container has been submitted has ceased.

Conveniently, the first and second detection units 30, 31 comprise respective optical detection devices 30a, 31a for measuring without contact the membrane 2.

An example of an optical detection device comprises a camera or a video-camera configured to detect the three-dimensional profile of the membrane 2 by analysing 3D images acquired, by optical scanning, from the respective detection device 30a, 31a.

In another embodiment, it can be provided that the optical detection device 30a, 31a comprises a photoelectric sensor, in particular a laser sensor, e.g. configured to detect points of the surface profile of the membrane.

The apparatus 100 further comprises a control unit 40, schematically shown in FIG. 1, which is operatively connected to the first and second detection units 30, 31, and is arranged to compare the first profile with the second profile of the container membrane, in order to detect whether the first profile differs from the second profile by an amount equal to or greater than a predefined threshold, in order to verify whether the tightness of the container is to be classified as defective.

With particular reference to FIG. 2, the method by which the apparatus 100 operates, for verifying the tightness of the containers 1 closed by their respective membranes 2, provides the sequence of the following operating steps, carried out while the plurality of containers 1 is led along the movement path in the transport direction F.

For ease of explanation, the method is hereinafter described with reference to one of the containers 1 of the plurality of containers, it being understood however that the entire plurality of containers is submitted to the steps of the method.

The method involves detecting the profile of the membrane of container 1 when the container, moved in the transport direction F, transits at the detection unit 30. In this position, the container is in a rest condition, i.e. it is submitted only to the force of gravity. Using an optical scan performed by the detection device 30a, a 3D image of the membrane 2 is acquired, from which the surface profile of the membrane is calculated and mapped relative to a reference plane. Conveniently, the reference plane can be defined by the plane to which points located at the edge 4, to which the membrane is fixed, belong.

In the section views of FIGS. 4 and 5, the reference plane is identified by a dotted line connecting diametrically opposite points of the edge 4. A first volume, referred to as V1, of the space between said reference plane and the surface profile of the membrane 2 identified as stated above, which is marked by N1 in FIG. 4, is calculated relative to this reference plane.

It should be noted that a so-called “normalisation” of the detected profile is thereby achieved, as it relates to the reference plane, which is identified in each container, with the advantage that the detection of the profile is therefore independent of the positioning of the container relative to the detection device.

In a following step, the method provides for the container 1 to be submitted to a deforming action exerted by the series of pairs of pressor elements 21, 22 which the container encounters in sequence during its movement in the transport direction F. This deforming action results, as the container moves, in a series of four successive squeezing actions, with alternating compression steps and release steps.

At a later stage, the container disengages from the deforming unit, thereby ceasing the deforming action, and the initial condition wherein the container, in its movement along the transport direction F, is exclusively submitted to the force of gravity, is restored.

The method provides that the container 1, once the deforming action has ceased, transits at the second detection unit 31, by means of which, through an optical scan performed by the detection device 31a, a 3D image of the membrane 2 is acquired. By means of image processing, the surface profile of the membrane is calculated and mapped in a similar way and with the same detection procedure as implemented in the detection unit 30. A second volume, referred to as V2, of the space between the corresponding reference plane and the surface profile of the membrane identified as stated above is then calculated. In FIG. 5, this profile of the membrane is marked by N2.

FIGS. 4 and 5 are representative of an example of a capsule which has a tightness defect. As a result of the deforming action, the profile of the membrane remains deformed in a convex pattern.

In the control unit 40, the comparison analysis between the first volume V1 and the second volume V2 is carried out, in order to identify whether and by how much the first volume V1 differs from the second volume V2, and to verify whether this difference is equal to or greater than a predefined threshold value, in order to ascertain whether the tightness of the container is to be classified as defective.

As a predefined threshold, a percentage of the difference between the first volume V1 and the second volume V2, for instance normalised relative to the first volume V1, can be selected.

A preferred range of values provides that the normalised threshold is between −15% and 30%.

In the case of a capsule classified as non-defective, referring to what represented in FIG. 3, if the profile of the membrane prior to the deforming action is shown in that FIG. 3, it is expected that the profile of the membrane after the release of the deforming action will reflect substantially the same pattern as in FIG. 3.

An alternative criterion, which can be applied to compare the profiles of the container, can provide to compare the surface extents of corresponding sections generated by vertical planes intersecting the reference plane and the three-dimensional profile of the membrane, rather than comparing volumes. The criterion may provide comparing surface extents generated in selected planes at corresponding positions relative to the membrane, measured upstream and downstream of the deforming unit.

Alternatively, it can be provided to identify a plurality of vertical planes and sum the surface extents identified, on each plane, by the intersection with the three-dimensional profile of the membrane and with the reference plane. The comparison made with these criteria, based on a more or less thorough discretisation, can allow for a simplification of calculation compared to criteria involving volume comparisons. Also when adopting these criteria, it is verified whether the calculated difference between the corresponding surface extents is equal to or greater than a predefined threshold value, in order to ascertain whether the tightness of the container is to be classified as defective. The following claim listing replaces all prior listings present in this application.

1. A method for testing the tightness of a container closed by a membrane comprising the steps of:
detecting a first profile of said membrane when said container and said membrane are in an initial force condition,
modifying said initial force condition submitting at least one of said container and said membrane to at least one deforming action such as to induce a deformation of said membrane,
interrupting said at least one deforming action so as to substantially restore said initial force condition,
detecting a second profile of said membrane after said at least one deforming action has been interrupted,
comparing said first profile with said second profile, and
identifying whether said first profile differs from said second profile by an amount equal to or greater than a predefined threshold, in order to verify whether the tightness of said container is to be classified as defective.

2. The method according to claim 1, wherein said initial force condition is a rest condition, wherein said container and said membrane are not submitted to mechanical deforming actions.

3. The method according to claim 1, wherein said container and said membrane in said initial force condition are in an atmospheric pressure environment.

4. The method according to claim 3, wherein the pressure in said container closed by said membrane is lower than said atmospheric pressure.

5. The method according to claim 1, wherein said first profile is detected by optical scanning of said membrane.

6. The method according to claim 5, wherein said optical scanning is extended over the entire surface of said membrane.

7. The method according to claim 1, wherein said deforming action comprises at least one localised squeezing action of said container.

8. The method according to claim 1, wherein said deforming action comprises a series of subsequent squeezing actions of said container.

9. The method according to claim 8, wherein said at least one squeezing action comprises a rapid compression step and is followed by a gradual release step, wherein said rapid compression step has a duration shorter than a duration of said gradual release step.

10. The method according to claim 7, wherein said at least one squeezing action is performed on diametrically opposite sides of said container.

11. The method according to claim 1, wherein a first volume and a second volume of space between said membrane and a reference plane are respectively derived from said first profile and said second profile.

12. The method according to claim 11, wherein said comparison is performed by comparing the values of said first volume and second volume.

13. An apparatus for testing the tightness of a container closed by a membrane comprising:
a first detection unit configured to detect a first profile of the membrane, when said container and said membrane are in an initial force condition,
a deforming unit designed to exert a deforming action on at least one of said container and said membrane such as to induce a deformation of said membrane,
a second detection unit configured to detect a second profile of the membrane when the deforming action has ceased and the initial force condition is substantially restored,
a control unit of said apparatus, operatively connected to said first and second detection units, and set up to compare said first profile with said second profile in order to detect whether said first profile differs from said second profile by an amount equal to or greater than a predefined threshold, in order to verify whether the tightness of said container is to be classified as defective.

14. The apparatus according to claim 13, wherein said deforming unit comprises at least one pair of pressor elements, between which the container is led to be submitted to a deforming action while transiting between said pressor elements.

15. The apparatus according to claim 14, wherein the pressor elements of said pair of pressor elements are rotatably supported about respective rotation axes parallel to each other.

16. The apparatus according to claim 14, comprising a plurality of pairs of said pressor elements arranged one after the other, at a selected relative distance, along an alignment direction.

17. The apparatus according to claim 16, wherein said direction of alignment of said pairs of pressor elements corresponds to a movement direction of the container.

18. The apparatus according to claim 13, further comprising a device for transporting the container wherein said deforming unit is mounted on a stationary support structure of the transport device.
